(19) United States
(12) Patent Application Publication
(10) Pub. No.: US 2008/0235228 A1
(43) Pub. Date: Sep. 25, 2008

(54) EFFICIENT STRING SORTING

(76) Inventors: Carmel Gerda Kent, Zippori (IL); Dafna Sheinwald, Nofit (IL)

Correspondence Address: Stephen C. Kaufman;IBM CORPORATION, Intellectual Property Law Dept., P.O. Box 218, Yorktown Heights, NY, 10598, US

(21) Appl. No.: 11/688,886

(22) Filed: Mar. 21, 2007

(51) Int. Cl. G06F 7/08

(52) U.S. Cl. 707/7; 707/E17.039

(57) ABSTRACT

A method for processing data includes reading respective initial substrings of the strings in a group, and computing respective codewords for the initial substrings. The codewords indicate differences between the substrings and point to the strings from which the substrings were respectively read. The codewords are arranged in a heap, which includes a tree of nodes. Each node has no more than two children and has a respective codeword pointing to a string that is in a predetermined ordinal relation, based on the lexicographical ordering, to the strings pointed to by the codewords of the children of the node. A list of one or more of the strings is output in accordance with a lexicographical ordering by selecting one or more of the nodes in the heap and reading the strings that are pointed to by the corresponding codewords.

### FIELD OF THE INVENTION

The present invention relates generally to data processing, and specifically to methods and systems for efficient sorting of character strings.

### BACKGROUND OF THE INVENTION

Various algorithms have been developed for sorting strings of characters into lexicographical order. Some applications call for sorting large numbers of strings, which may use characters drawn from large alphabets. In such cases, the strings to be sorted may not all fit together in the internal memory of the computer, and transferring the string data between internal and external memory can be a major performance bottleneck.

One of the best-known methods for sorting lists of strings (as well as other ordered elements) is Quicksort. This algorithm uses a “divide and conquer” strategy to partition the group of strings into two sub-lists about a “pivot,” so that all strings that are less than the pivot (i.e., earlier in the lexicographical order) come before the pivot, and all strings greater than the pivot come after it. The two sub-lists, above and below the pivot, are re-partitioned recursively until the entire list has been sorted. The best-known implementation of Quicksort for lexicographical sorting of strings over unbounded alphabets is the one described by Bentley and Sedgwick in “Fast Algorithms for Sorting and Searching Strings,” Eighth Annual ACM-SIAM Symposium on Discrete Algorithms (SIAM Press, 1997).

Baer and Lin introduced the use of codewords in string sorting, in “Improving Quicksort Performance with a Codeword Data Structure,” IEEE Transactions on Software Engineering 15 (1989), pages 622-631. The codeword is a compact representation of a key with respect to some codeword generator. (The codeword generator and the key may be strings of characters.) The codeword consists of a byte for a character count of bytes that are equal in the key and codeword generator, a byte for the first non-equal byte, and a pointer to the record that is indicated by the key. The authors showed how the ordering of keys is preserved by an adequate choice of the codeword generator and how the use of codewords, rather than pointers, can be applied to the Quicksort algorithm.

### SUMMARY OF THE INVENTION

In an embodiment of the present invention, a method for processing data includes receiving a group of strings, each string including a respective sequence of characters selected from a predefined alphabet having a lexicographical ordering. Respective initial substrings of the strings in the group are read, and respective codewords are computed for the initial substrings. The codewords indicate differences between the substrings and pointing to the strings from which the substrings were respectively read. The codewords are arranged in a heap, which includes a tree of nodes. Each node has no more than two children and has a respective codeword pointing to a string that is in a predetermined ordinal relation, based on the lexicographical ordering, to the strings pointed to by the codewords of the children of the node if the node has one or more children. A list of one or more of the strings is outputted in accordance with the lexicographical ordering by selecting one or more of the nodes in the heap and reading the strings that are pointed to by the corresponding codewords.

Other embodiments provide apparatus and a computer software product.

The present invention will be more fully understood from the following detailed description of the embodiments thereof, taken together with the drawings in which:

### BRIEF DESCRIPTION OF THE DRAWINGS

FIG. 1 is a schematic, pictorial illustration showing a system for sorting strings, in accordance with an embodiment of the present invention;

FIG. 2 is a graph that schematically illustrates a data structure used in string sorting in accordance with an embodiment of the present invention;

FIG. 3 is a flow chart that schematically illustrates a method for sorting strings, in accordance with an embodiment of the present invention; and

FIG. 4 is a flow chart that schematically illustrates a method for arranging codewords in a heap, in accordance with an embodiment of the present invention.

### DETAILED DESCRIPTION OF EMBODIMENTS

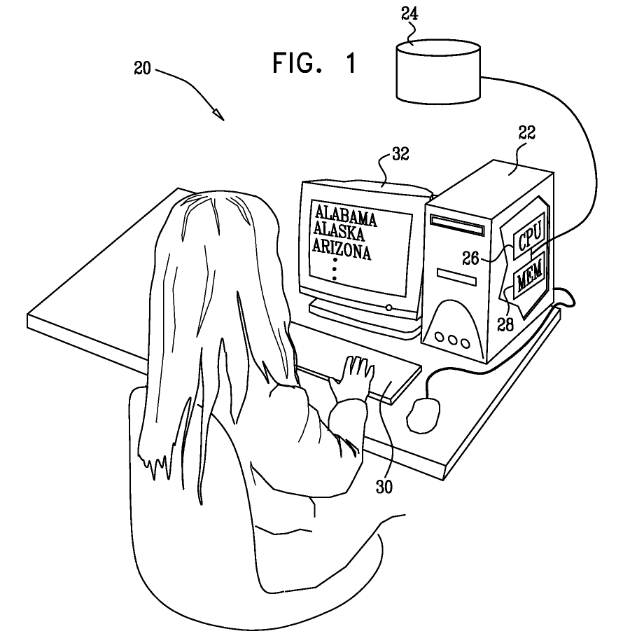

FIG. 1 is a schematic pictorial illustration of a system 20 for sorting strings, in accordance with an embodiment of the present invention. The system comprises a string processor 22, which is configured to search and sort a large corpus of strings, which are stored in a repository 24. For example, processor 22 may comprise a search engine, such as the IBM OmniFind™ Enterprise Edition (Version 8.4), which searches repository 24 for information that satisfies a certain user-defined query. This search engine permits the user to specify one of the fields of the records in the list of query results to serve as a sort key, and then presents the results in ascending or descending order of the values of the specified field. Textual keys are sorted lexicographically.

Processor 22 typically comprises a general-purpose computer, which is programmed in software to carry out the functions that are described hereinbelow. The computer comprises a central processing unit (CPU) 26, which is coupled to an internal memory 28, i.e., memory that is accessible by the CPU without the use of the computer input/output (I/O) channels. Memory 28 typically comprises random access memory (RAM), although other types of memory may also be coupled internally to the system bus of the CPU for use as internal memory. Repository 24, on the other hand, typically comprises external memory, which is accessed by CPU 26 via I/O channels, such as network or disk interfaces. Repository 24 may comprise any suitable type of storage medium or media. Although the repository is shown in FIG. 1 in the form of a single disk unit that is physically external to processor 22, the repository may alternatively be distributed among different storage media at one or multiple different locations, and some or all of the storage media making up the repository, such as a disk drive, may be located within the processor housing itself.

Processor 22 receives user queries via an input device 30, such as a keyboard. After processing the query, the processor outputs a list of strings corresponding to the query results via an output device 32, such as a display. Frequently, processor 22 may be instructed to arrange the output strings, for the convenience of the user, in lexicographical order. The user may view all the results in this manner or, particularly when a given query generates a large number of results, the user may request that the processor output the top k results (wherein k is a user-specified or default integer). As another alternative, the user may request that the processor output the results one by one or in successive groups of k results (k>1), starting from the top of the order and continuing down until the user decides to stop, without necessarily having specified in advance the number of results to be output.

Processor 22 typically performs these search, sorting and output tasks under the control of software running on CPU 26. (Although only a single CPU is shown and described here for simplicity, in practice processor 22 may comprise multiple processing units, which may be located in a single box or distributed among multiple, networked housings in one location or multiple locations.) The software may be downloaded to processor 22 in electronic form, over a network, for example, or it may alternatively be provided on tangible media, such as optical, magnetic or electronic memory media.

Lexicographical sorting of strings, such as is performed by processor 22, can consume extensive computing time, particularly when the alphabet of characters from which the strings are built is large, and internal memory 28 is limited. For example, the computing time required to sort n strings, of total length N, using the above-mentioned Quicksort method, as described by Bentley and Sedgwick is O(n·log n+N) on average, using O(n) internal memory space. In embodiments of the present invention, however, processor 22 uses a novel heap-based sorting method that requires O(n·log n+N) computing time in the worst case. If only the top k results are required, the worst-case computing time and memory space requirements may be reduced still further. Details of this method are described hereinbelow.

In the context of the present patent application and in the claims, a string s of length m over an alphabet Σ is defined as a sequence of m characters s[1],s[2], . . . , s[m], each character a member of Σ. The alphabet may be unbounded but has a known lexicographical ordering. The characters may comprise letters of a language or substantially any other type of symbols that have a defined lexicographical ordering. For purposes of the methods that follow, we define the artificial character “0”. This character is not a member of Σ, but it is comparable with and smaller than any of the characters in Σ. For i>length(s), s[i]=0. A substring s [i, j] is defined for 1≦i≦j≦m as the sequence s[i], s[i+1], . . . , s[j]. When i>j, s[i, j] is the empty string of length zero.

In defining the lexicographical ordering of strings 40, we will use the notation s₁<s₂ to indicate that s₁ precedes s₂ in the ordering. Formally, s₁<s₂ means that there is an index j between 1 and L (the maximum string length) such that s₁[i]=s₂[i] for all 1≦i<i, and s₁[j]<s₂[i]. If s₁ is a strict prefix of s₂, then s₁<s₂. Strings s₁ and s₂ are considered equal if and only if s₁ [i]=s₂[] for all 1≦i≦L.

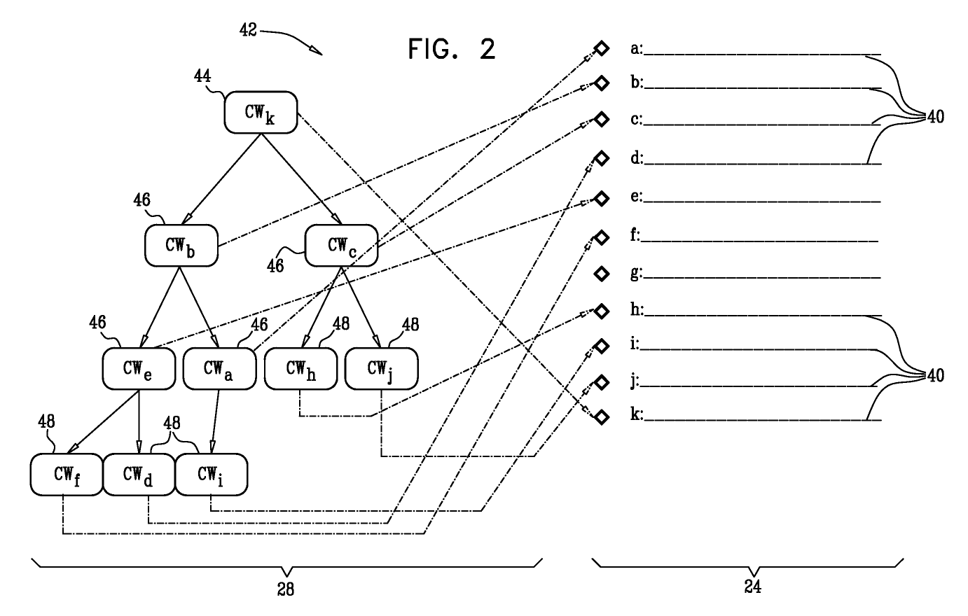

FIG. 2 is a graph that schematically illustrates a heap data structure 42 that is used in sorting strings 40, in accordance with an embodiment of the present invention. Strings 40, labeled a, b, . . . , k in this example, are typically located in repository 24. Each string is represented by a codeword CWₐ, CW_{b}, . . . , CWₖ in data structure 42. The codewords are computed, as described below, on the basis of substrings of a given length, consisting of one or more characters, that are read out of repository 24 into memory 28. The substrings are read out of repository 24 incrementally, as needed for the purpose of lexicographical sorting, rather than reading the full-length strings 40 into memory 28.

Each codeword in data structure 42 is a value (typically of constant size, in bits) that is associated respectively with a given string 40 and is computed with respect to another string. Formally, codewords are defined herein as follows:
Given strings s₁ and s₂ over an alphabet Σ, the codeword of s₁ with respect to s₂, denoted CWₛ_{₂} (s₁), is the ordered triple (i, s₁[i], ptr₁), wherein i is the earliest position at which s₁ differs from s₂, and ptr₁ is the pointer to string s₁ itself. If s₁=s₂, then CWₛ_{₂} (s₁)=(∞, 0, ptr₁).
   A codeword C₁=(i₁, a₁, ptr₁) with respect to some reference string is said to be smaller than C₂=(i₂, a₂, ptr₂) with respect to the same reference string (i.e., C₁<C₂) if i₁<i₂ or if i₁=i₂ and a₁<a₂.

It can be shown that the ordinal relation of the codewords of a pair of strings s₁ and s₂ with respect to another string s₃, which is larger than both s₁ and s₂, is indicative of the lexicographical order of the pair of strings. Formally, this property of the codewords can be expressed as follows (assuming s₁, s₂<s₃):

CWₛ_{₃}(s₁)<CWₛ_{₃}(s₂) implies that s₁<s₂. (1)

CWₛ_{₃}(s₁)=CWₛ_{₃}(s₂)=(i, a) for i<∞ (omitting the pointer values) implies that the order of s₁ and s₂ is determined by their suffixes starting at position i+1. (2)

It can also be shown that:

if CWₛ_{₃}(s₁)<CWₛ_{₃}(s₂), then CWₛ_{₃}(s₁)=CWₛ_{₂}(s₁). (3)

These properties of codewords are used in sorting and recomputing the codewords in data structure 42, as described hereinbelow.

Data structure 42 comprises a heap, which is a balanced, full-binary tree. The heap structure itself is well known in the art, although it is used in a novel way in the present embodiment for sorting strings to which the codewords in the heap refer. The nodes of the heap comprise a root 44, intermediate nodes 46, and leaves 48. Each node thus has either zero, one or two children, wherein the leaves have no children, and at most one node 46 has a single child, which is a leaf 48. The respective distances of leaves 48 from root 44 differ from one another by no more than one hop. A heap of n nodes may be conveniently held in an array of length n, with the children of node i held in positions 2i+1 and 2i+2 (so that the parent of node i is in position └(i−1)/2┘). Parent-child relationships are thus maintained without the use of explicit pointers.

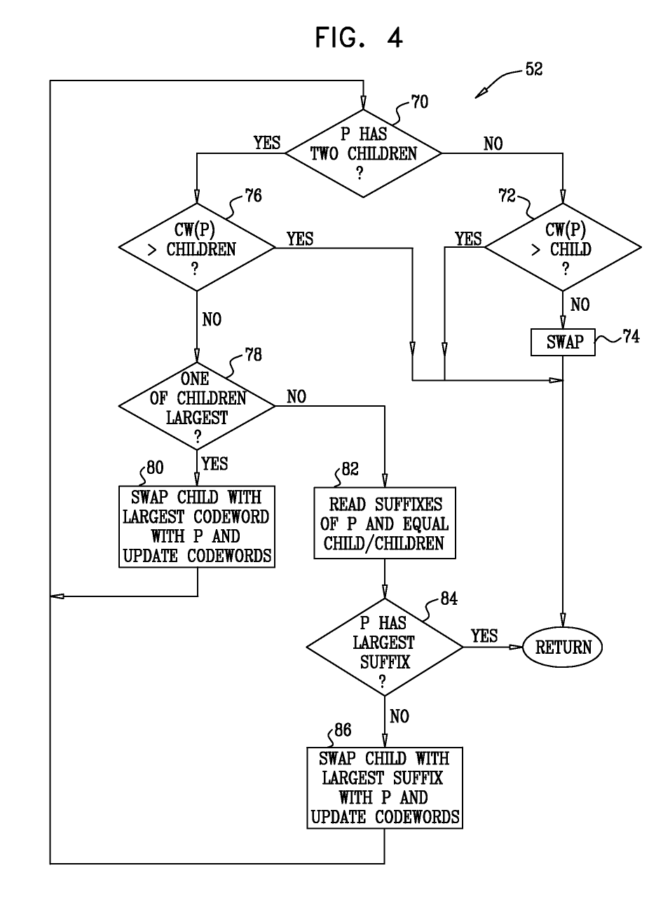

The string pointed to by the codeword held by any given parent node in the heap is in a predetermined ordinal relation to the string pointed to by the codewords held by its children. In the description that follows, it will be assumed that for purposes of lexicographical ordering, the nodes of the heap are ordered so that every parent string is greater than or equal to its child strings. A systematic procedure (“Heapify”) for arranging a group of strings so that they obey the above heap ordering is shown hereinbelow in FIG. 4. (Also, as a result of this procedure, the codeword of each node, other than the root, is set to be the codeword of the string belonging to that node with respect to the string of the parent node.) After heap ordering has been applied to all the strings and codewords in data structure 42, the largest string will be located at root 44. The codeword of each child node is computed with respect to the string pointed to by its parent. The Heapify procedure described below also provides, when a parent codeword is found to be equal to the codeword of one or both of its children, for recomputing and then (if necessary) reordering the codewords based on the suffixes of the corresponding strings.

As a result, when data structure 42 has been completely “heapified,” the codeword pointing to the largest string is located at root 44. Likewise, the string that is pointed to by any parent node 46 is greater than or equal to the string or strings pointed to by its children.

In the embodiment described above, the codeword at root 44 will point to the largest string (i.e., the last string in lexicographical order) of the strings in the group represented by the heap. In alternative embodiments, the heap may be arranged so that the codeword at the root points to the smallest string. For example, the heap may be defined so that each parent string is less than or equal to its child strings, and the Heapify procedure may be modified accordingly. As another option, the definition of codewords given above may be modified to be CW=(i, −a), meaning that for the purpose of comparing codewords, the lexicographic order of the characters in the alphabet is reversed. The procedures described hereinbelow will then yield a heap in which smaller strings have larger codewords, and the smallest string is located at the root of the tree.

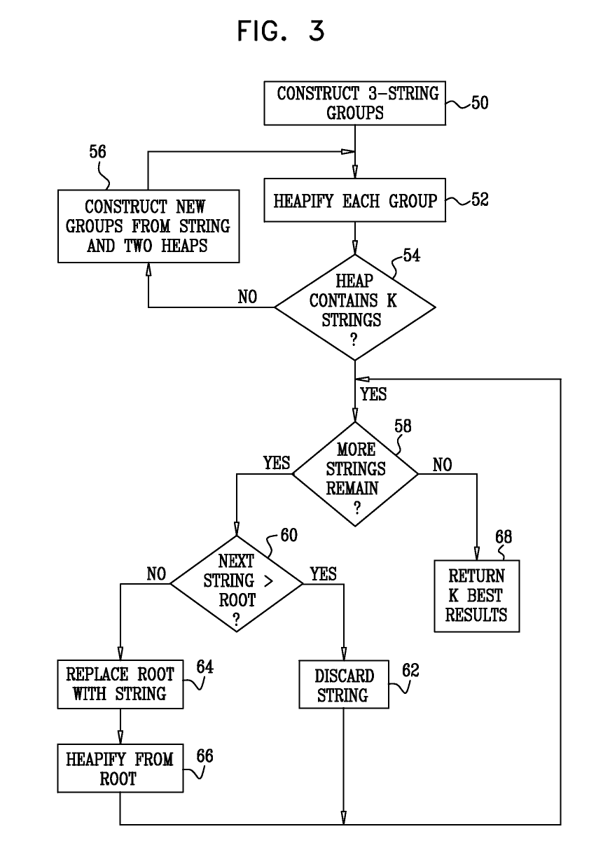

FIG. 3 is a flow chart that schematically illustrates a method for lexicographical sorting of strings, in accordance with an embodiment of the present invention. The object of this method is to find the “k best results” out of a set of n strings in repository 24, i.e., the first k strings in a lexicographical ordering of the strings. The method may, of course, be extended to order all of the strings simply by setting k=n.

Processor 22 initiates the method by constructing a heap containing a group of k strings, selected arbitrarily from the n strings in the set. One method for constructing this heap is to build (k+1)/2 trivial one-element heaps, each comprising a codeword pointing to one string. These one-element heaps are used to build three-element heaps, comprising three codewords each, by adding another element on top (i.e., at the root) of each pair of one-element heaps, at an initial heap grouping step 50. The Heapify procedure, as described below, is applied to each three-element heap, at a heapifying step 52. As a result, the root of each three-element heap points to the largest string in the corresponding group of three, and the codewords of the strings pointed to by the leaves of the heap are computed with respect to the string at the root.

In order to build and heapify each of these heaps, as well as the larger heaps that are constructed as the method progresses, it is not generally necessary that the processor read out all the characters in each of the strings from repository 24. Rather, the processor may read out only an initial substring (comprising one or more characters) from each of the strings in question from repository 24 into internal memory 28, and may compute the codewords on the basis of the substrings alone. (To build the three-element heaps at step 50, the processor reads out initial substrings of the three strings in question, finds the largest of the three strings, and then computes the codewords of the other two strings with respect to the largest string.) If the initial substrings of a certain pair (or triple) of strings are equal, then the processor attempts to order the strings based on the suffixes. In other words, the processor reads out successive substrings of the suffixes of these initial substrings from repository 24 incrementally until it reaches a point at which the suffixes are different. This method of incremental readout from repository 24 is useful in reducing the amount of internal memory 28 that is required for this method, as well as reducing the number of characters that must actually be processed by CPU 26.

After completing the heapifying procedure at step 52, processor 22 checks whether the composite heap now contains all k strings in the initial group, at a heap size checking step 54. If not, the processor constructs a new heap by combining each pair of heaps from the preceding stage with one of the remaining (unheaped) strings in the group, at a new heap grouping step 56. For example, the processor combines each pair of three-element heaps with another element at the top to make a seven-element tree, and so forth until all of the k elements have been incorporated. (If necessary, the processor may incorporate one or more five-element trees alongside the seven-element trees in order to maintain the balance of the final tree, so that the distances of leaves 48 from root 44 differ from one another by no more than one hop, as noted above.)

After each pass through step 56, processor 22 heapifies each of the resulting trees at step 52. At the final pass through step 54, the processor will have constructed a heap containing codewords pointing to all of the k strings in the initial group, arranged in heap order. The largest string in the initial group will thus be at root 44 of this k-string heap.

Processor 22 now checks whether there are any more strings remaining to be sorted in the set of n strings, at a remainder checking step 58. If so, the processor reads out the initial substring of a new string from repository 24 and compares it to the initial substring of the string pointed to by root 44, at a next string comparison step 60. If the initial substrings are equal, then the processor proceeds to check the respective suffixes, as explained above. If the new string is found in this manner to be greater than the string currently pointed to by the root, then this new string is necessarily greater than all of the other strings currently in the k-element heap and therefore cannot possibly be one of the k best results. Therefore, processor 22 discards this new string, at a discard step 62, and goes on to check the next new string in the set.

On the other hand, if the processor finds the new string selected at step 60 to be smaller than the current root string, it replaces the current root string with this new string, at a root replacement step 64. The processor then heapifies the tree, starting from the new root, at a tree heapifying step 66. Again, the processor carries out the heapify procedure as shown below in FIG. 4. For this purpose, the processor computes the codeword of the new string with respect to the previous root, and compares it with the codewords of the two children of the root. (The codeword computation for the new string can take place simultaneously with comparison of the new string with the previous root string at step 60.) If the root codeword is smaller than one or both of the child codewords, it will be swapped with the greater of its children. If the root codeword is equal to one or both of the child codewords, the processor compares the respective strings beginning from the offsets indicated by the codewords until it finds the first character at which the strings differ, and swaps the strings (and recomputes the codeword of the smaller string), if necessary, on that basis. This procedure continues iteratively until the codeword of the new string that was added at the root at step 64 has moved down to its proper location in the heap order.

Processor 22 goes back to step 58 to determine whether any more strings remain to be sorted. As long as more new strings remain in the set of n strings, the processor continues to iterate through steps 58-66. When all of the n strings have been sorted in this manner, the codewords remaining in the heap point to the k best results in the set. Processor 22 returns these results at an output step 68.

In an alternative embodiment, a similar technique may be used to output the best result (i.e., the first string in the lexicographical order), followed by an arbitrary number of next-best results in succession. For this purpose, processor 22 builds a heap containing all of the n strings in the set that is to be sorted, as in steps 50-56 of the method described above. In this case, however, the heap is arranged so that the root codeword points to the first string in the lexicographical ordering, rather than the last of the k strings as in the method of FIG. 3. The processor may, for example, use the alternative definition of codewords that was given above, in which the codeword contains the inverse of the character at the earliest position at which the string in question differs from the reference string. Thus, after sorting the n strings into this heap, the processor returns the string pointed to by the root as the best result.

Should the user request the next-best result, processor 22 removes the root codeword from the tree, and returns the string that is pointed to by the best child of the root, i.e., the child having the larger codeword (or the smaller suffix, if the codewords of the children are equal). At this point, after removing the root, the processor has two sub-trees, each in heap order. In order to provide the third-best result (after the original root and the best child), the processor promotes the best child to the root. To fill the empty spot left by the best child, the processor chooses and promotes the child having the greater codeword (or smaller suffix) from among the two children of the best child, and thus proceeds iteratively to reconstruct a single tree until it has reached the leaves. The resulting tree may no longer be balanced, but it will still obey the basic heap ordering property that the string of each node is not larger than the strings of its children. The codeword of each child remains as computed with respect to the string of its parent.

For example, referring back to FIG. 2, after returning string k as the best result, processor 22 may determine that CW_{b} is greater than CW_{c}, and will therefore promote the best child, CW_{b}, to root 44. Assuming CWₐ is greater than CWₑ, the processor will promote CWₐ to the node formerly occupied by CW_{b}, and will promote CWi to the node formerly occupied by CWₐ. After returning string b as the next-best result, the processor will compare CWₐ to CW_{c}, and will choose whichever one is greater to promote to root 44 in place of CW_{b}, and will promote the nodes below it as in the preceding iteration.

FIG. 4 is a flow chart that schematically shows details of heapifying step 52, in accordance with an embodiment of the present invention. The method is iterative and may be applied to a heap of substantially any size. It assumes that the strings pointed to by the nodes below a certain node p in the tree are themselves in heap order, but the string pointed to by node p may be out of heap order with respect to the nodes below p in the tree. The method swaps the codewords of parent nodes with those of their children as necessary from p downward in order to restore the proper heap order. Codewords are recomputed as necessary, as noted above, so that the codeword of the string at each child node is computed with respect to its parent node.

Processor 22 determines whether p has one child or two, at a topology evaluation step 70. If p has a single child, then by definition of the heap structure, the child node is a leaf. The processor checks the codeword of p, CW(p), against the codeword of the child, at a single codeword comparison step 72. If the codeword of p is less than that of the child node, the processor swaps the two codewords, at a node swapping step 74. If the codewords are equal, the processor reads the suffixes of the corresponding strings incrementally until it determines which of the strings is greater. If the string pointed to by p is less than that pointed to by the child node, then the processor likewise swaps the codewords at step 74. Otherwise, the processor concludes that the order of p and its child node is correct. In either case (nodes swapped or not), the Heapify routine terminates (returns), since it has reached a leaf.

If p has two children, processor 22 compares CW(p) to the codewords of its two children, at a dual codeword comparison step 76. If CW(p) is the largest of the three, the processor concludes that the nodes are properly ordered, and the routine terminates. If either or both of the children have codewords greater than or equal to CW(p), however, the processor determines whether one the children has the largest codeword of the three nodes in question, at a child selection step 78. If so, the processor swaps the codeword of p with the larger of the child codewords, at a node swapping step 80. (In situations in which the children have equal codewords that are larger than CW(p), the processor compares the suffixes of the two child strings in order to find the greater of the two, and then swaps p with the greater child.) By property (2) above, there is no need to recompute the codeword of p after the swap.

After swapping p with one of its children at step 80, processor 22 must now determine whether p is in proper heap order with respect to its new children at the next level down the tree. If p is now in a leaf position, there is no need for such a determination, and the method terminates. Otherwise, the processor iterates to step 70, and compares CW(p) to the codewords of the new child or children, as described above.

On the other hand, if processor 22 finds at step 78 that CW(p) is equal to the codeword of either or both of its children, the processor reads and compares the subsequent substrings in the suffixes of the corresponding strings, at a suffix reading step 82. The processor continues until it finds a character at which the strings differ, and on this basis determines whether the suffix of p is the largest, at a suffix comparison step 84. If so, the processor concludes that p is in proper heap order with respect to its children, and the method terminates. Otherwise, the processor swaps p with the child node that has the largest suffix, at a node swapping step 86. The codewords are recomputed to accord with the new order of the nodes in the tree. Unless p is now in a leaf position, the method iterates again to step 70, as explained above.

Details of steps 82-86 are provided in pseudocode form in Appendix A below. Procedure 1 in the appendix is applied in cases in which p is found at step 78 to have the same codeword as one of its children (which is greater than the codeword of the other child). Procedure 2 is applied when the codewords of p and both of its children are all equal.

The methods described above can be used in substantially any application that requires a large number of strings to be sorted. These methods are particularly advantageous, however, in dealing with long strings and/or large alphabets, such as DNA sequences or texts in oriental languages. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

APPENDIX A
PSEUDOCODE LISTINGS

```
Procedure 1
(l,j,(i,a)) ← TwoStrings(s₁,s₂,p)
Compares two strings and form the codeword of the smaller with respect to the larger
Require: strings s₁ and s₂ , and the length p ≧ 0 of their common prefix, i.e., s₁[1,p] = s₂[1,p]
Ensure: identification of the index l of the larger string, the index j of the smaller string, and
  computation of the codeword (i,a) of sⱼ with respect to sₗ.
1: i ← p + 1
2: while s₁[i] = s₂[i] and i ≦ L do {L is an upper hound on all string lengths}
3:  i ← i + 1
4: end while
5: if i > L then {input strings are identical}
6:  return (1,(∞,0)) {pick 1 arbitrarily}
7: end if
8: if s₁[i] < s₂[i] then
9:  return (2,1,(i,s₁[i]))
10: else
11:  return (1,2,(i, s₂[i]))
12: end if
Procedure 2
(l,j,(iⱼ,aⱼ),k,(iₖ,aₖ)) ← ThreeStrings(s₁,s₂,s₃,p)
Arranges three strings so that the smaller two get Codewords with respect to larger one
Require: strings s₁, s₂, and s₃, and length p ≧ 0 of common prefix, i.e., s₁[1, p] = s₂[1,p] = s₃[1,p]
Ensure: identification of the indices j,k,l such that sⱼ ≦ sₖ ≦ sₗ, and computation of the
  codewords CW [symbol] (sⱼ) = (iⱼ,aⱼ) and CW [symbol] (sₖ) = (iₖ,aₖ).
1: i ← p + 1
2: while s₁[i] = s₂[i] = s₃[i] and i ≦ L do {L is an upper bound on all string lengths}
3:  i ← i + 1
4: end while
5: if i > L then {input strings are all identical}
6:  return (1,2,(∞,0),3,(∞,0))
7: end if
8: one-to-one map {j,k,l,} to {1,2,3} such that sⱼ[i] ≦ sₖ[i] ≦ sₗ[i]. {At least one of the
  inequalities must be strict. The codeword of sⱼ wrt sₗ is now determined.}
9: if sₖ[i] < sₗ[i] then {sₗ is larger than each of the other two}
10:  return (l,j,(i,sⱼ[i]),k,(i,sₖ[i]))
11: end if
  {We know here that sⱼ < sₖ = sₗ}
12: m ← i {record offset i}
13: while sₖ[i] = sₗ[i] and i ≦ L do
14:  i ← i + 1
15: end while
16: if i > L then {sₖ = sₗ}
17:  return (l,k,(∞,0),j,(m,sⱼ[m]))
18: end if
19: if sₖ[i] < sₗ[i] then {sₖ < sₗ}
20:  return (l,k,(i,sₖ[i]),j,(m,sⱼ[m]))
21: else {sₖ > sₗ}
22:  return (k,l,(i,sₗ[i]),j,(m,sⱼ[m]))
23: end if [symbol]
indicates data missing or illegible when filed
```

1. A method for processing data, comprising:
receiving a group of strings, each string comprising a respective sequence of characters selected from a predefined alphabet having a lexicographical ordering;
reading respective initial substrings of the strings in the group;
computing respective codewords for the initial substrings, the codewords indicating differences between the substrings and pointing to the strings from which the substrings were respectively read;
arranging the codewords in a heap, which comprises a tree of nodes, each node having no more than two children and having a respective codeword pointing to a string that is in a predetermined ordinal relation, based on the lexicographical ordering, to the strings pointed to by the codewords of the children of the node if the node has one or more children; and
outputting a list of one or more of the strings in accordance with the lexicographical ordering by selecting one or more of the nodes in the heap and reading the strings that are pointed to by the corresponding codewords.

2. The method according to claim 1, wherein outputting the list comprises receiving a query specifying a number k of the strings, and selecting for output the first k strings in the lexicographical ordering.

3. The method according to claim 2, wherein the heap comprises a root node, and wherein arranging the codewords building the heap so that the heap contains the codewords of the first k strings according to the ordinal relation, and the root node corresponds to the codeword pointing to the last string among the first k strings, while discarding from the heap the codewords of the strings that follow the string pointed to by the respective codeword corresponding to the root node according to the ordinal relation.

4. The method according to claim 1, wherein the heap comprises a root node, and wherein outputting the list comprises selecting for output a string that is pointed to by the respective codeword corresponding to the root node, and comprising:
removing the root node from the tree;
after removing the root node, repeating the step of arranging the codewords so as to choose a new root node; and
selecting for output a further string that is pointed to by the respective codeword corresponding to the new root node.

5. The method according to claim 1, wherein arranging the codewords comprises, at each given node in the tree:
if the respective codewords of the given node and of the one or more chidren of the given node are different, arranging the codewords so as to maintain a predetermined order of the codewords in the heap; and
if the respective codewords of the given node and of at least one child node of the given node are equal:
reading respective suffixes of the initial substrings of the strings that are pointed to by the respective codewords of the given node and the at least one child node; and
arranging the nodes in the tree so as to maintain the predetermined ordinal relation with respect to the suffixes.

6. The method according to claim 5, wherein reading the respective initial substrings comprises reading the substrings into an internal memory of a computer, which performs the steps of computing and arranging the codewords, and wherein receiving the group of strings comprises storing the strings in an external memory, which is separate from the internal memory, and
wherein reading the respective suffixes comprises transferring into the internal memory the suffixes of the initial substrings of the strings in the external memory that are pointed to by the respective codewords of the given node and the at least one child node responsively to determining that the respective codewords of the given node and of the at least one child node are equal.

7. The method according to claim 5, wherein computing the respective codewords comprises computing the respective codeword of each child node with respect to a parent node of the child node in the tree, and wherein arranging the nodes comprises swapping the parent and child nodes to maintain the predetermined ordinal relation, and recomputing at least one of the codewords responsively to swapping the nodes.

8. Apparatus for processing data, comprising:
a repository, which is arranged to hold a group of strings, each string comprising a respective sequence of characters selected from a predefined alphabet having a lexicographical ordering; and
a string processor, which is arranged to read respective initial substrings of the strings in the group, to compute respective codewords for the initial substrings, the codewords indicating differences between the substrings and pointing to the strings from which the substrings were respectively read, to arrange the codewords in a heap, which comprises a tree of nodes, each node having no more than two children and having a respective codeword pointing to a string that is in a predetermined ordinal relation, based on the lexicographical ordering, to the strings pointed to by the codewords of the children of the node if the node has one or more children, and to output a list of one or more of the strings in accordance with the lexicographical ordering by selecting one or more of the nodes in the heap and reading the strings that are pointed to by the corresponding codewords.

9. The apparatus according to claim 8, wherein the string processor is arranged to receive a query specifying a number k of the strings, and to select for output the first k strings in the lexicographical ordering.

10. The apparatus according to claim 9, wherein the heap comprises a root node, and wherein the string processor is arranged to build the heap so that the heap contains the codewords of the first k strings according to the ordinal relation, and the root node corresponds to the codeword pointing to the last string among the first k strings, while discarding from the heap the codewords of the strings that follow the string pointed to by the respective codeword corresponding to the root node according to the ordinal relation.

11. The apparatus according to claim 8, wherein the heap comprises a root node, and wherein the string processor is arranged to select for output a string that is pointed to by the respective codeword corresponding to the root node, and then to remove the root node from the tree, and after removing the root node, to rearrange the codewords so as to choose a new root node and to select for output a further string that is pointed to by the respective codeword corresponding to the new root node.

12. The apparatus according to claim 8, wherein the string processor is configured to arrange the codewords at each given node in the tree so as to maintain a predetermined order of the codewords if the respective codewords of the given node and of the one or more chidren of the given node are different, and if the respective codewords of the given node and of at least one child node of the given node are equal, to read respective suffixes of the initial substrings of the strings that are pointed to by the respective codewords of the given node and the at least one child node, and to arrange the nodes in the tree so as to maintain the predetermined ordinal relation with respect to the suffixes.

13. The apparatus according to claim 12, and comprising an internal memory associated with the string processor, while the repository comprises an external memory, which is separate from the internal memory, and
wherein the string processor is arranged to read the initial substrings from the external memory into the internal memory, and then, responsively to determining that the respective codewords of the given node and of the at least one child node are equal, to transfer the suffixes of the initial substrings of the strings that are pointed to by the respective codewords of the given node and the at least one child node from the external memory into the internal memory.

14. The apparatus according to claim 12, wherein the string processor is arranged to compute the respective codeword of each child node with respect to a parent node of the child node in the tree, and to swap the parent and child nodes to maintain the predetermined ordinal relation, and to recomputed at least one of the codewords responsively to swapping the nodes.

15. A computer software product, comprising a computer-readable medium in which program instructions are stored, which instructions, when read by a computer that is in communication with a repository holding a group of strings, each string comprising a respective sequence of characters selected from a predefined alphabet having a lexicographical ordering, cause the computer to read respective initial substrings of the strings in the group, to compute respective codewords for the initial substrings, the codewords indicating differences between the substrings and pointing to the strings from which the substrings were respectively read, to arrange the codewords in a heap, which comprises a tree of nodes, each node having no more than two children and having a respective codeword pointing to a string that is in a predetermined ordinal relation, based on the lexicographical ordering, to the strings pointed to by the codewords of the children of the node if the node has one or more children, and to output a list of one or more of the strings in accordance with the lexicographical ordering by selecting one or more of the nodes in the heap and reading the strings that are pointed to by the corresponding codewords.

16. The product according to claim 15, wherein the instructions cause the computer to receive a query specifying a number k of the strings, and to select for output the first k strings in the lexicographical ordering.

17. The product according to claim 16, wherein the heap comprises a root node, and wherein the instructions cause the computer to build the heap so that the heap contains the codewords of the first k strings according to the ordinal relation, and the root node corresponds to the codeword pointing to the last string among the first k strings, while discarding from the heap the codewords of the strings that follow the string pointed to by the respective codeword corresponding to the root node according to the ordinal relation.

18. The product according to claim 15, wherein the heap comprises a root node, and wherein the instructions cause the computer to select for output a string that is pointed to by the respective codeword corresponding to the root node, and then to remove the root node from the tree, and after removing the root node, to rearrange the codewords so as to choose a new root node and to select for output a further string that is pointed to by the respective codeword corresponding to the new root node.

19. The product according to claim 15, wherein the instructions cause the computer to arrange the codewords at each given node in the tree so as to maintain a predetermined order of the codewords if the respective codewords of the given node and of the one or more chidren of the given node are different, and if the respective codewords of the given node and of at least one child node of the given node are equal, to read respective suffixes of the initial substrings of the strings that are pointed to by the respective codewords of the given node and the at least one child node, and to arrange the nodes in the tree so as to maintain the predetermined ordinal relation with respect to the suffixes.

20. The product according to claim 19, wherein the repository comprises an external memory, which is separate from an internal memory of the computer, and
wherein the instructions cause the computer to read the initial substrings from the external memory into the internal memory, and then, responsively to determining that the respective codewords of the given node and of the at least one child node are equal, to transfer the suffixes of the initial substrings of the strings that are pointed to by the respective codewords of the given node and the at least one child node from the external memory into the internal memory.
